(19) United States
(12) Patent Application Publication
(10) Pub. No.: US 2026/0140882 A1
(43) Pub. Date: May 21, 2026

(54) STORAGE DEVICE, STORAGE SYSTEM, AND OPERATING METHOD OF STORAGE DEVICE

(71) Applicant: Samsung Electronics Co., Ltd., Suwon-si (KR)

(72) Inventors: Seongnam Kwon, Suwon-si (KR); Jaesub Kim, Suwon-si (KR); Jeayoung Kwon, Suwon-si (KR)

(21) Appl. No.: 19/359,150

(22) Filed: Oct. 15, 2025

(30) Foreign Application Priority Data
Nov. 20, 2024 (KR) 10-2024-0166609

(51) Int. Cl. G06F 12/0871; G06F 12/02

(52) U.S. Cl. CPC G06F 12/0871; G06F 12/0246; G06F 12/0253; G06F 2212/1021

(57) ABSTRACT

A storage device includes a memory, a non-volatile memory device, and storage controller configured to control the non-volatile memory device, communicate with an external host, and perform a map cache operation for each user based on requirements of multiple users and input/output patterns of the multiple users, in which the storage controller includes a map cache manager configured to allocate a first map area of the memory for first map data corresponding to a first user, allocate a second map area of the memory for second map data corresponding to a second user, manage the first map data based on a first map cache policy corresponding to the first user, and manage the second map data based on a second map cache policy corresponding to the second user.

### CROSS-REFERENCE TO RELATED APPLICATIONS

This application claims priority under 35 U.S.C. §119 to Korean Patent Application No. 10-2024-0166609, filed on Nov. 20, 2024, in the Korean Intellectual Property Office, the disclosure of which is incorporated by reference herein in its entirety.

### BACKGROUND

Semiconductor memory devices are classified into volatile memory devices, which lose the stored data when power supply thereto is cut off, such as static random access memory (SRAM) and dynamic RAM (DRAM), and non-volatile memory devices, which maintain the stored data even when power supply thereto is cut off, such as flash memory, phase RAM (PRAM), magnetic RAM (MRAM), resistive RAM (RRAM), and ferroelectric RAM (FRAM).

An example of a storage device based on a flash memory device includes a solid state drive (SSD). Interfaces used in storage devices, such as SSDs, include a serial advanced technology attachment (SATA), a peripheral component interconnect express (PCIe), a serial attached small computer system interface (SAS), a compute express link (CXL), and so on, and an interface based on a PCIe bus, such as a non-volatile memory express (NVMe), is also proposed.

In addition, a storage device may be shared by one or more hosts, and multiple users may access the storage device through each host. As storage devices increase in capacity, on-demand loading for map data is expected to be utilized. When map cache operations are performed in a multi-user environment without considering requirements and input/output patterns of each user, an interface between users may increase, which may cause an issue of decreasing the overall performance of the storage device. Also, because the input/output patterns of each user are mixed in the multi-user environment, it is difficult to analyze patterns for each user, and thus, an issue arises in which it is difficult to optimize map management considering the patterns.

### SUMMARY

In general, the present disclosure is directed toward a storage device, a storage system, and an operating method of the storage device that provide stable performance or improved performance.

According to some implementations, the present disclosure is directed to a storage device that includes a memory, a non-volatile memory device, and a storage controller configured to control the non-volatile memory device, communicate with an external host, and perform a map cache operation for each user, of a plurality of users, based on user requirements and data access patterns of the plurality of users, wherein the storage controller includes a map cache manager configured to allocate a first map area of the memory for first map data corresponding to a first user, allocate a second map area of the memory for second map data corresponding to a second user, manage the first map data based on a first map cache policy corresponding to the first user, and manage the second map data based on a second map cache policy corresponding to the second user.

According to some implementations, the present disclosure is directed to a storage system that includes a host including a host processor and a host memory, and a storage device including a storage controller, a memory, and a non-volatile memory device, wherein the storage controller is configured to allocate map areas of the memory for storing map data respectively corresponding to a plurality of users based on user requirements of the plurality of users and data access patterns of the plurality of users, and wherein the storage controller is configured to manage the map data respectively corresponding to the plurality of users based on map cache policies respectively corresponding to the plurality of users, and on the user requirements of the plurality of users and the data access patterns of the plurality of users.

According to some implementations, the present disclosure is directed to an operating method of a storage device that includes receiving, by a user profile manager, user requirements for a plurality of users from an external host, performing, by the user profile manager, a monitoring operation for the plurality of users and determining data access patterns for the plurality of users, individually allocating, by a map cache manager, map areas of a memory for the plurality of users based on user requirements of the plurality of users and the data access patterns of the plurality of users, and individually determining, by the map cache manager, map cache policies corresponding to the plurality of users based on the user requirements and the data access pattern of the plurality of users.

### BRIEF DESCRIPTION OF THE DRAWINGS

Example implementations will be more clearly understood from the following detailed description, taken in conjunction with the accompanying drawings.

FIG. 1 is a block diagram illustrating an example of a storage system including a storage device according to some implementations

FIG. 2 is a block diagram illustrating an example of a storage controller of FIG. 1 according to some implementations.

FIG. 3 is a block diagram illustrating an example of a storage system according to some implementations.

FIG. 4 is a flowchart illustrating an example of an operating method of the storage system of FIG. 1 according to some implementations.

FIG. 5 is a flowchart illustrating an example of an operating method of the storage controller of FIG. 1 according to some implementations

FIG. 6 is a flowchart illustrating an example of an operating method of the storage device of FIG. 1 according to some implementations.

FIG. 7A to FIG. 7D are diagrams illustrating example operations of the storage system of FIG. 1 according to some implementations.

FIG. 8A to 8C are diagrams illustrating example operations of the storage system of FIG. 1 according to some implementations

FIG. 9 is a diagram illustrating an example of an operation of the storage system of FIG. 1 according to some implementations.

FIG. 10 is a flowchart illustrating an example of an operating method of the storage device of FIG. 1 according to some implementations.

FIG. 11 is a block diagram illustrating an example of the storage system of FIG. 1 according to some implementations

FIG. 12 is a flowchart illustrating an example of an operating method of the storage system of FIG. 1 according to some implementations.

FIG. 13 is a flowchart illustrating an example of the operating method of the storage device of FIG. 1 according to some implementations.

FIG. 14 is a diagram illustrating an example of a system according to some implementations.

FIG. 15 is a block diagram illustrating an example of a computing system according to some implementations.

### DETAILED DESCRIPTION

Hereinafter, example implementation will be explained in detail with reference to the accompanying drawings.

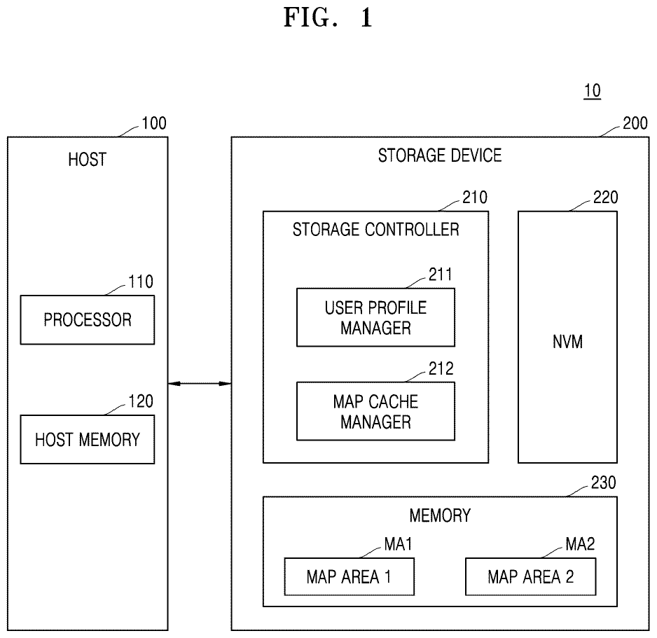

FIG. 1 is a block diagram illustrating an example of a storage system including a storage device according to some implementations. In FIG. 1, a storage system 10 may include a host 100 and a storage device 200. The storage device 200 may include a storage controller 210, a non-volatile memory device 220, and a memory 230. Although only one host 100 is illustrated in FIG. 1, two or more hosts may share the storage device 200.

In some implementations, multiple users(e.g., plurality of users) may share the storage device 200. For example, multiple users may provide the storage device 200 with a request (or a command) instructing the host 100 to write or read data. For example, a user may be a user device, a client, a virtual machine, or an application.

In some implementations, the storage controller 210 and the non-volatile memory device 220 may be implemented as separate semiconductor chips. Also, components of the present disclosure may be defined by various other terms. For example, the storage device 200 may be referred to as a memory system or a data processing system, and the storage controller 210 may be referred to as a memory controller or so on.

The storage device 200 may include storage media that store data according to a request from the host 100. For example, the storage device 200 may include at least one solid state drive (SSD). When the storage device 200 includes an SSD, the non-volatile memory device 220 may include a plurality of flash memory chips (for example, a plurality of NAND chips) that store data in a non-volatile manner.

Also, the storage device 200 may include, for example, various types of memories. For example, the storage device 200 may also include non-volatile memories, such as magnetic random access memory (MRAM), spin-transfer torque MRAM, conductive bridging RAM (CBRAM), ferroelectric RAM (FeRAM), phase RAM (PRAM), resistive RAM, nanotube RAM, polymer RAM (PoRAM), nano floating gate memory (NFGM), holographic memory, molecular electronics memory, and insulator resistance change memory.

The storage device 200 may communicate with the host 100 through various interfaces. For example, the storage device 200 may communicate with the host 100 through various interfaces, such as a Universal Serial Bus (USB), a multimedia card (MMC), a peripheral component interconnect express (PCIe), an advanced technology attachment (ATA), a serial ATA (SATA), a parallel ATA (PATA), a small computer system interface (SCSI), a serial attached SCSI (SAS), an enhanced small disk interface (ESDI), an integrated drive electronics (IDE), a compute express link (CXL), and a non-volatile memory express (NVMe).

According to some implementations, the host 100 may include a processor 110 and a host memory 120. The processor 110 may control all operations of the host 100 by executing commands stored in the host memory 120. The host 100 may encode or decode packets that satisfy a standard defined in a preset interface. The host 100 may generate a packet instructing recording or reading as a command. Also, the host 100 may receive a response provided from the storage device 200.

The non-volatile memory device 220 may include at least one NAND chip (or at least one non-volatile memory), and the at least one NAND chip may include a memory cell array and a peripheral circuit. For example, the peripheral circuit of the at least one NAND chip may perform operations of data recording, data reading, and data erasing under the control by the storage controller 210, and the memory cell array of the at least one NAND chip may include one or more blocks.

The host 100 may include a command memory storing a command and a response memory (not illustrated) storing a response. For example, the host memory 120 may include a command memory and a response memory. In some implementations, the command memory may be included in the host 100 as a separate memory. In addition, the response memory may also be included in the host memory 120 or may also be provided as a separate memory. The host 100 may store commands generated by multiple users in the command memory. For example, the command memory may include multiple command queues storing multiple commands, and the multiple command queues may be allocated to multiple users. For example, when an NVMe interface is used in the storage system 10, the command queue may correspond to a submission queue (SQ) defined in the NVMe interface.

The storage device 200 may perform memory operations, such as data writing and data reading, by fetching commands stored in the command queues and executing the commands. Also, commands provided to the storage device 200 may include information on the command queues, and as different command queues are respectively allocated to users, the storage device 200 may determine the user who provides the command through the information included in the command. That is, the command may include a command queue identifier. In some implementations, the command may also include information (for example, a user identifier (or, a user identification (ID))) indicating a user instead of information of a command queue, and the storage device 200 may also determine a user who provides the command based on the user identifier. That is, the command may include a user identifier.

The memory 230 may store data or output the stored data under the control by the storage controller 210. In some implementations, the memory 230 may be a volatile memory. For example, the memory 230 may be dynamic random access memory (DRAM). However, the scope of the present disclosure is not limited thereto. In some implementations, the memory 230 may include a buffer area and a map table area. The buffer area of the memory 230 may store data before the data is stored in the non-volatile memory device 220. For example, data fetched by the host 100 may be stored first in the memory 230. Thereafter, the data stored in the memory 230 may be stored in a space indicated by an allocated physical address (PA) of the non-volatile memory device 220. The data read from the non-volatile memory device 220 may be stored in the buffer area of the memory 230 before being transmitted to the host 100. For example, the data loaded from the non-volatile memory device 220 may be first stored in the buffer area of the memory 230. Thereafter, the data stored in the buffer area of the memory 230 may be transmitted to the host 100.

For example, the buffer area may store the data received from the non-volatile memory device 220 or the data received from the host 100. The mapping table area may refer to an area storing map data (or a map table). The mapping table area may store map data received from the non-volatile memory device 220. A map table or some pieces of map data stored in the non-volatile memory device 220 may be stored in the map table area of the memory 230. The map data or map table may include mapping information between a logical address (LA) received from the host 100 and a PA of the storage device 200.

For example, the mapping table area may include a plurality of map areas. The memory 230 may include a first map area MA1 and a second map area MA2. The map table area of the memory 230 may include the first map area MA1 and the second map area MA2. However, the scope of the present disclosure is not limited thereto, and the number of map areas included in the map table area of the memory 230 may increase or decrease depending on implementation. The storage device 200 may individually store and individually manage map tables or map data for multiple users. For example, the first map area MA1 may store a map table or map data corresponding to a first user. The second map area MA2 may store a map table or map data corresponding to a second user.

The storage controller 210 may control the non-volatile memory device 220. The storage controller 210 may communicate with the host 100. The storage controller 210 may include a user profile manager 211 and a map cache manager 212.

When map caching is performed in a multi-user environment without considering requirements and data access patterns (e.g., input/output patterns) of a user, an issue may occur in which an action of a certain user affects map cache management of another user. Due to this, it is difficult to analyze patterns for each user and optimize the map cache management for each user. In order to solve the issue, optimized map cache management that meets requirements of each user is required by performing a map cache operation for each user by using a mass storage device.

The user profile manager 211 may manage respective characteristics of multiple users. The user profile manager 211 may manage respective input/output patterns of multiple users. The user profile manager 211 may receive user requirements from the host 100. The user profile manager 211 may manage and store the user requirements. The user profile manager 211 may perform a monitoring operation to detect input/output patterns of multiple users. The user profile manager 211 may detect, manage, and store the input/output patterns of multiple users. The user profile manager 211 may provide the map cache manager 212 with user considerations and the input/output patterns.

The map cache manager 212 may perform map caching because a storage space of the memory 230 is limited. This is because there is not enough space to load the entire map table or the entire map data into the storage space of the memory 230. Accordingly, the map cache manager 212 may use the memory 230 by caching map data only when necessary. However, in a process of performing the map caching, an issue of increased latency and decreased performance may occur, and a more efficient map caching method is required to solve the issue.

The storage system 10 may perform a map cache operation for each user. The storage system 10 may individually manage a map table or map data for each user. The storage system 10 may perform a map cache operation for each user based on the user requirements and input/output patterns. For example, the user requirements may include user information or user characteristics. The user requirements may include performance bandwidth information, latency information, capacity information, input/output pattern information, and frequency information.

In some implementations, the map cache manager 212 may manage the map cache within the allocated map area. For example, the map cache manager 212 may allocate the first map area MA1 to a first user and may manage map data related to the first user within the first map area MA1. The map cache manager 212 may load or unload map data within the first map area MA1.

The map cache manager 212 may set the size of a map area, set map cache policy, and set a mapping method based on the user requirements and data access (e.g., input/output) patterns. Accordingly, the map cache manager 212 may increase a cache hit ratio.

As described above, the storage system 10 may perform a map cache operation for each user in a multi-user environment, based on requirements and data access (e.g., input/output) patterns of multiple users. The storage device 200 may independently manage map data to suit user requirements or patterns for each user. Accordingly, the storage device 200 may improve input/output latency, improve user experience through improved performance, and also manage map caching itself more efficiently.

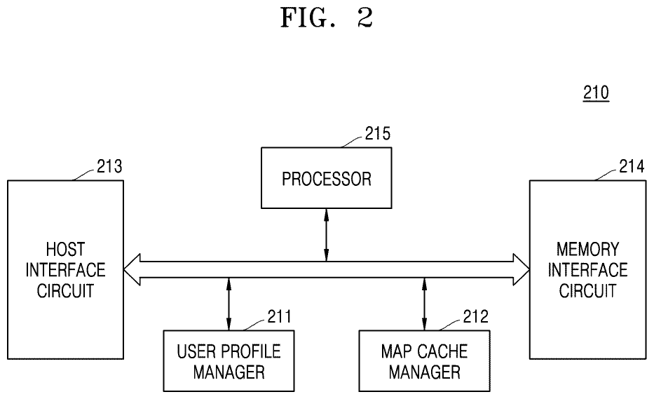

FIG. 2 is a block diagram illustrating an example of the storage controller 210 of FIG. 1 according to some implementations. In FIGS. 1 and 2, the storage controller 210 may include the user profile manager 211, the map cache manager 212, a host interface circuit 213, a memory interface circuit 214, and a processor 215. In some implementations, various types of software capable of being executed by the processor 215 may be loaded into the memory 230, and for example, a flash translation layer (FTL) may be loaded into the memory 230.

Also, when a function of the user profile manager 211 is implemented in software, a user profile management module including one or more commands may be loaded into the memory 230. When a function of the map cache manager 212 according to some implementations is implemented in software, a map cache management module including one or more commands may be loaded into the memory 230.

The processor 215 may control all operations of the storage controller 210 by executing various types of software (or commands) stored in the memory 230. The host interface circuit 213 may perform communication with the host according to various interfaces, such as an NVMe. Also, the memory interface circuit 214 provides an interface with one or more NAND chips included in the non-volatile memory device 220 (see FIG. 1), and for example, the memory interface circuit 214 may perform independent communication with the one or more NAND chips through a plurality of channels.

The user profile manager 211 may receive requirements (or characteristics) of multiple users from the host 100. The user profile manager 211 may receive user requirements through the host interface circuit 213. The user profile manager 211 may manage the requirements of multiple users. The user profile manager 211 may provide the user requirements to the map cache manager 212.

The user profile manager 211 may perform monitoring operations for multiple users. The user profile manager 211 may detect input/output patterns for multiple users. The user profile manager 211 may analyze the monitoring operations to determine input/output patterns for multiple users. The user profile manager 211 may manage the input/output patterns for multiple users. The user profile manager 211 may provide the input/output patterns to the map cache manager 212. The user profile manager 211 may include hardware, software, or a combination of hardware and software configured to manage the operations described above.

The map cache manager 212 may perform a map cache operation. The map cache manager 212 may perform a map cache operation on map data stored in the non-volatile memory device 220 because the memory 230 does not have enough space. The map cache manager 212 may store, in the map table area of the memory 230, some pieces of the map data stored in the non-volatile memory device 220.

In some implementations, the map cache manager 212 may cache address mapping information managed by the storage device 200. For example, the map cache manager 212 may cache some pieces frequently accessed among multiple pieces of address mapping information and manage some pieces of address mapping information as a map table. In other words, the map cache manager 212 may manage address mapping between a PA and an LA.

The map cache manager 212 may perform a map cache operation for each user. The map cache manager 212 may individually manage map data for each user. The map cache manager 212 may cache only the map data corresponding to the first user in the first map area MA1 and may cache map data corresponding to the second user in the second map area MA2.

The map cache manager 212 according to some implementations may set sizes of map areas, set a mapping method, or determine and manage a map cache policy. The map cache manager 212 may manage the sizes of map areas, the mapping method, and the map cache policy based on user requirements and input/output patterns. Accordingly, the map cache manager 212 may optimize performance for each user. The map cache manager 212 may have hardware, software, or a combination of hardware and software configured to manage the operations described above.

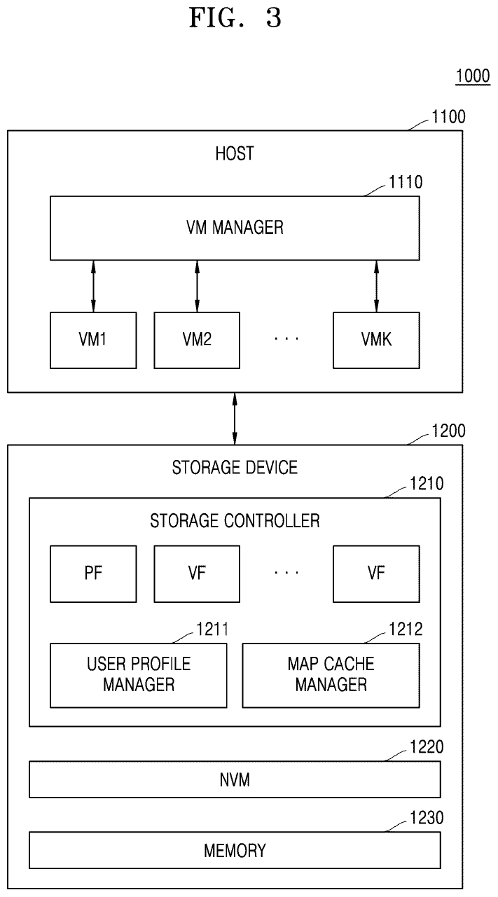

FIG. 3 is a block diagram illustrating an example of a storage system according to some implementations. In FIGS. 1 and 3, a storage system 1000 of FIG. 3 may correspond to the storage system 10 of FIG. 1, a host 1100 of FIG. 3 may correspond to the host 100 of FIG. 1, and a storage device 1200 of FIG. 3 may correspond to the storage device 200 of FIG. 1.

In FIG. 3, the storage system 1000 may include the host 1100 and the storage device 1200. The host 1100 may generate a plurality of virtual machines VM based on virtualization technology and may generate first, second, . . . , K^{th} virtual machines VM1, VM2, . . . , VMK. For example, one virtual machine among the first to K^{th} virtual machines VM1 to VMK may be allocated to each of multiple users. For example, a first user may correspond to the first virtual machine VM1, and a second user may correspond to the second virtual machine VM2. Hereinafter, a user may refer to a virtual machine. Hereinafter, for the sake of convenience of description, the terms “user”, “virtual machine”, “application”, “client’, and so on are used interchangeably. The terms may have the same meaning or different meanings depending on contexts of implementations, and meanings of the terms may be understood according to contexts of the implementations to be described.

The host 1100 may include a virtual machine manager 1110 and may generate the first to K^{th} virtual machines VM1 to VMK under the control by the virtual machine manager 1110. In some implementations, the virtual machine manager 1110 may generate an SQ corresponding to a command queue according to a request of a virtual machine and allocate the SQ to the virtual machine. The host 1100 may also further include completion queues that store responses provided from the storage device 1200.

The storage device 1200 may include a storage controller 1210, a non-volatile memory device 1220, and a memory 1230, and the storage controller 1210 may include one or more physical functions PF, a plurality of virtual functions VF, a user profile manager 1211, and a map cache manager 1212. As a single root input/output virtualization (SR-IOV) function is provided according to an NVMe interface, the storage device 1200 may generate the plurality of virtual functions VF. The plurality of virtual functions VF may be implemented in a storage controller of the storage device 1200 in response to a request from the host 1100, and the one or more physical functions PF and the plurality of virtual functions VF may each process a data access request from the host 1100. Also, each virtual machine may correspond to a physical function or virtual function, and each user may provide a command to the non-volatile memory device 1220 through a virtual machine allocated to each user and a corresponding physical function (or a corresponding virtual function).

The user profile manager 1211 may manage requirements and input/output patterns of the first to K^{th} virtual machines VM1 to VMK. The user profile manager 1211 may receive and store requirements of the first to K^{th} virtual machines VM1 to VMK. The user profile manager 1211 may perform monitoring operations on the first to K^{th} virtual machines VM1 to VMK. The user profile manager 1211 may analyze results of the monitoring operations to detect input/output patterns. For example, the input/output patterns may include a sequential pattern, a random pattern, a pattern that repetitively accesses only a preset address area, a pattern that periodically accesses a preset size unit, and so on.

In some implementations, the map cache manager 1212 may manage map cache based on characteristics of the first to K^{th} virtual machines VM1 to VMK. Based on requirements and input/output patterns of the first to K^{th} virtual machines VM1 to VMK, the map cache manager 1212 may allocate a map area of the memory 230 for storing map data corresponding to the plurality of virtual machines VM1 to VMK. For example, the map cache manager 1212 may allocate a first map area MA1 for the first virtual machine VM1. The map cache manager 1212 may store map data corresponding to the first virtual machine VM1 in the first map area MA1. The map cache manager 1212 may allocate a second map area MA2 for the second virtual machine VM2. The map cache manager 1212 may store map data corresponding to the second virtual machine VM2 in the second map area MA2.

The map cache manager 1212 may manage map data respectively corresponding to the first to K^{th} virtual machines VM1 to VMK based on map cache policies respectively corresponding to the first to K^{th} virtual machines VM1 to VMK, based on requirements and input/output patterns of the first to K^{th} virtual machines VM1 to VMK. For example, the map cache manager 1212 may manage map data corresponding to the first virtual machine VM1 based on a first map cache policy corresponding to the first virtual machine VM1. The map cache manager 1212 may manage the first map area MA1 based on the first map cache policy.

As described above, the storage device 200 may manage map data by considering the first to K^{th} virtual machines VM1 to VMK. The storage device 200 may perform map caching by considering the first to K^{th} virtual machines VM1 to VMK. Accordingly, the storage device 200 with improved performance may be provided.

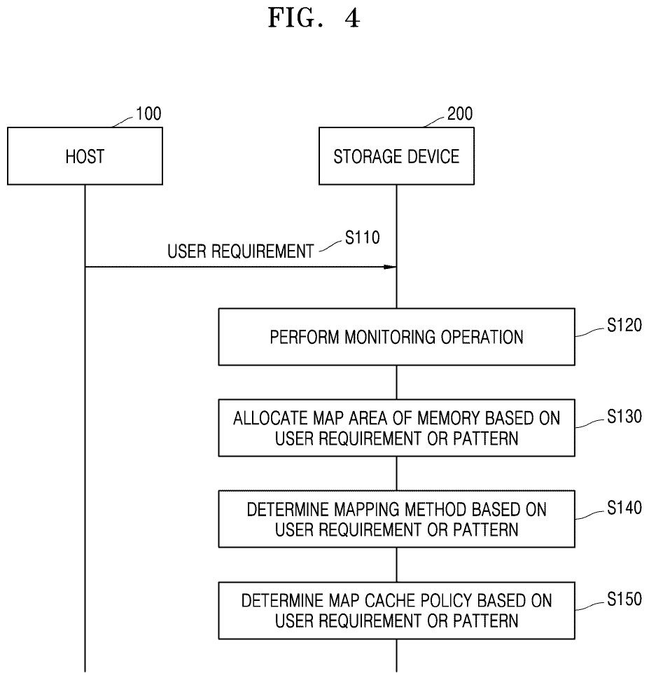

FIG. 4 is a flowchart illustrating an example of an operating method of the storage system 10 of FIG. 1 according to some implementations. In FIGS. 1 and 4, the storage system 10 may perform a map cache operation for each user. The storage system 10 may perform a user-customized map cache operation in a multi-user environment.

In operation S110, the host 100 may transmit a user request to the storage device 200. The host 100 may transmit requirements of multiple users to the storage device 200. For example, the host 100 may transmit a requirement of a first user and a requirement of a second user to the storage device 200. In some implementations, a first virtual machine may transmit a requirement of the first virtual machine to the storage device 200, and a second virtual machine may transmit a requirement of the second virtual machine to the storage device 200. For example, the requirements may include information on a user or virtual machine, such as performance, a bandwidth, an input/output pattern, and capacity. In some implementations, the requirements may indicate user information or virtual machine information.

In operation S120, the storage device 200 may perform a monitoring operation. The storage device 200 may perform a monitoring operation of monitoring input/output patterns of multiple users (or multiple virtual machines). The storage device 200 may perform the monitoring operation to generate a monitoring result. The storage device 200 may analyze the monitoring result to determine input/output patterns of multiple users.

In operation S130, the storage device 200 may allocate a map area of the memory 230 based on a user requirement or pattern. For example, the storage device 200 may allocate map areas respectively corresponding to multiple users. The storage device 200 may allocate the first map area MA1 to a first user and the second map area MA2 to a second user. In some implementations, the memory 230 may include the first map area MA1 and the second map area MA2. The first map area MA1 may be separated from the second map area MA2. For example, the size of the first map area MA1 may be different from the size of the second map area MA2.

In operation S140, the storage device 200 may determine a mapping method based on a user requirement or pattern. For example, the mapping method may include a first mapping method and a second mapping method. The first mapping method may indicate a page mapping method, and the second mapping method may indicate a block mapping method. For example, when an input/output pattern of a first user is a sequential pattern, the storage device 200 may determine a block mapping method for the first user. When the input/output pattern of the first user is a random pattern, the storage device 200 may determine a page mapping method for the first user.

The storage device 200 may determine a mapping method for each of multiple users based on user requirements or patterns. For example, the storage device 200 may determine the first mapping method for a first user and determine the second mapping method for a second user.

In operation S150, the storage device 200 may determine a map cache policy based on user requirements or patterns (or regularities). In some implementations, the map cache policy may indicate a replacement policy. The map cache policy may indicate a policy for determining whether to prefetch map data, determining which map data to load into a cache, and determining which map data to remove (or unload) from the cache. The storage device 200 may determine a map cache policy for each of multiple users based on user requirements or patterns. For example, the storage device 200 may determine a first map cache policy for a first user and determine a second map cache policy for a second user.

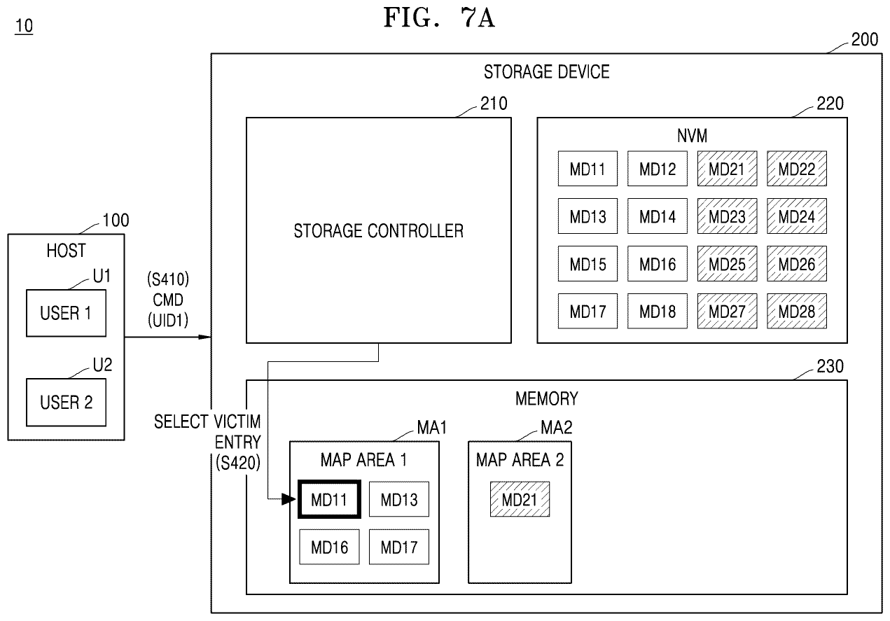

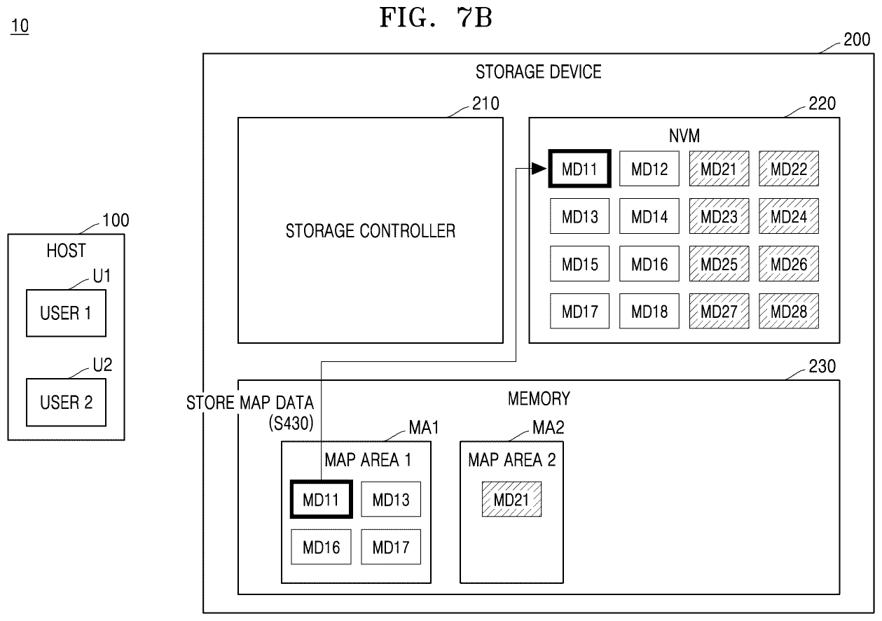

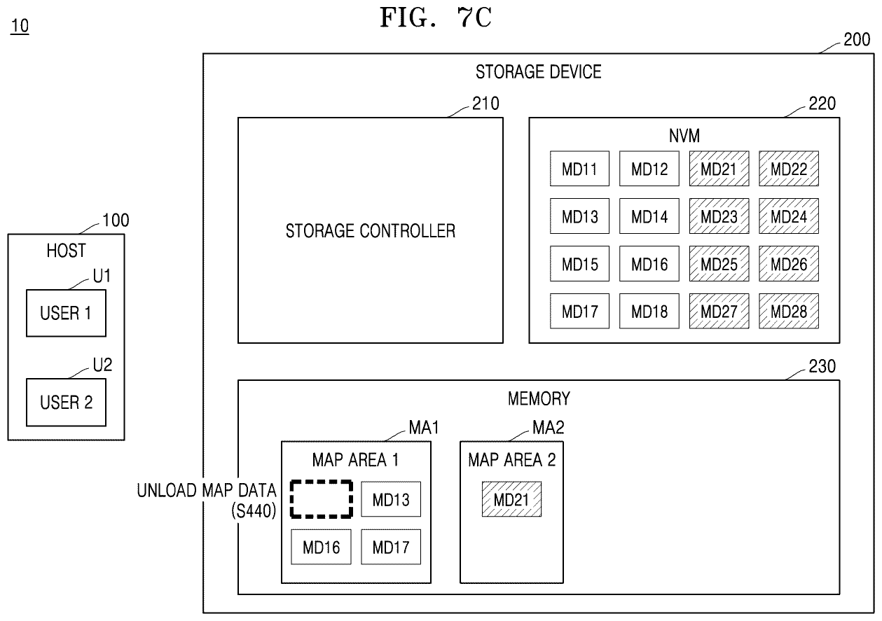

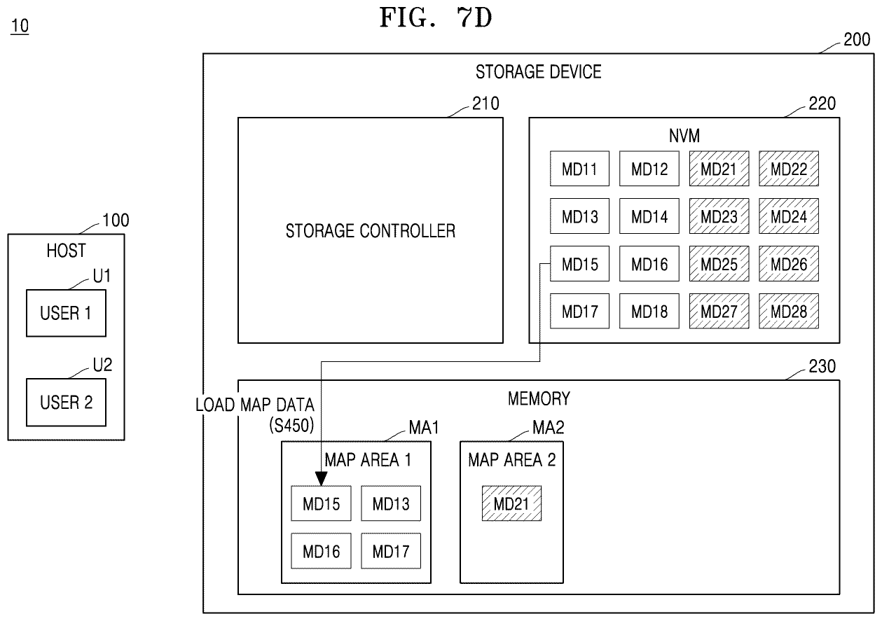

For example, when an input/output pattern of a first user U1 (see FIG. 7A) is a sequential pattern, the storage device 200 may determine a map cache policy for prefetch for the first user U1. For example, when an input/output pattern of the first user U1 is a pattern of accessing data at regular intervals (strides), the storage device 200 may determine a map cache policy for prefetching (or loading) map data for the first user U1 according to a corresponding unit.

In some implementations, during a process in which the storage device 200 performs a map cache operation for each user, either operation S110 or operation S120 may be omitted. Also, during the process in which the storage device 200 performs the map cache operation for each user, one of operation S130 to operation S150 may be omitted. During the process in which the storage device 200 performs the map cache operation for each user, at least one of operation S130 to operation S150 may be performed.

As described above, the storage system 10 may separately manage map tables for each user. The storage system 10 may differently set map cache policies, map area sizes, and mapping methods for each user according to the input/output patterns or requirements of users. Accordingly, the storage system 10 may reduce the influence of an operation of the first user on the second user in a multi-user environment.

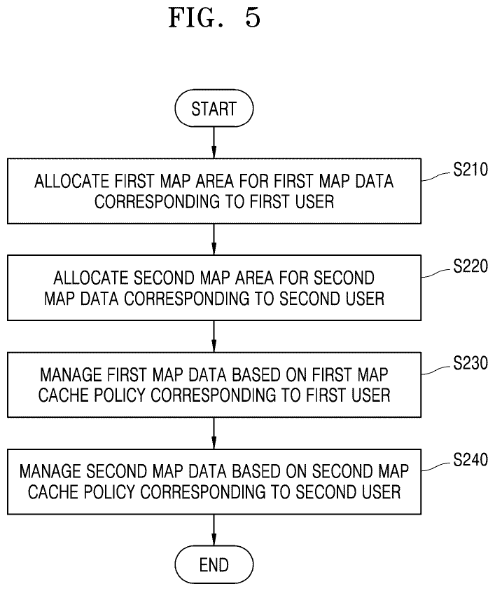

FIG. 5 is a flowchart illustrating an example of an operating method of the storage controller 210 of FIG. 1 according to some implementations. In FIGS. 1 and 5, in operation S210, the storage controller 210 may allocate the first map area MA1 for first map data corresponding to a first user. For example, the first map data may indicate map data related to the first user. The storage controller 210 may allocate the first map area MA1 to the first user based on a requirement or input/output pattern of the first user. The storage controller 210 may allocate the first map area MA1 having a first size.

In operation S220, the storage controller 210 may allocate the second map area MA2 for second map data corresponding to a second user. For example, the second map data may indicate map data related to the second user. The storage controller 210 may allocate the second map area MA2 to the second user based on a requirement or input/output pattern of the second user. The storage controller 210 may allocate the second map area MA2 having a second size. The second size may be equal to or different from the first size.

In operation S230, the storage controller 210 may manage the first map data based on a first map cache policy corresponding to the first user. The storage controller 210 may determine the first map cache policy based on requirements or input/output patterns of the first user.

In operation S240, the storage controller 210 may manage the second map data based on a second map cache policy corresponding to the second user. For example, the second map cache policy may be the same as or different from the first map cache policy. The storage controller 210 may determine the second map cache policy based on requirements or input/output patterns of the second user.

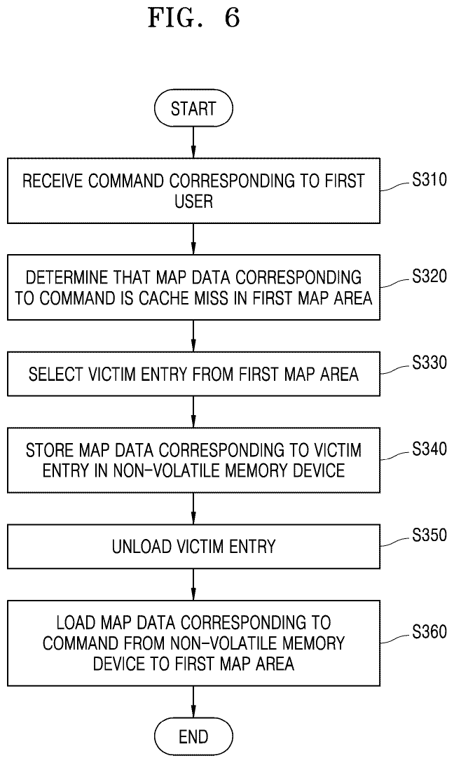

FIG. 6 is a flowchart illustrating an example of an operating method of the storage device 200 of FIG. 1 according to some implementations. In FIGS. 1 and 6, the storage device 200 may perform a map cache operation for each user. The storage device 200 may perform the map cache operation for each user based on requirements of multiple users and input/output patterns of multiple users. The storage device 200 may allocate the first map area MA1 of a memory for first map data corresponding to a first user U1 (see FIG. 7A), allocate the second map area MA2 of the memory for second map data corresponding to a second user U2 (see FIG. 7A), manage the first map data based on a first map cache policy corresponding to the first user U1, and manage the second map data based on a second map cache policy corresponding to the second user U2.

In some implementations, map replacement may occur in a map area allocated to each user. Accordingly, interference between users may be reduced. When a command corresponding to the first user U1 is received, the storage device 200 may perform map replacement in the first map area MA1 corresponding to the first user U1. When a command corresponding to the second user U2 is received, the storage device 200 may exchange a map in the second map area MA2 corresponding to the second user.

In operation S310, the storage device 200 may receive a command corresponding to the first user U1 from the host 100. For example, the storage device 200 may identify multiple users by using one of a command queue identifier, a namespace identifier, and a user identifier included in the command. For example, the command may be either a read command or a write command.

In operation S320, the storage device 200 may determine that the map data corresponding to the command is a cache miss in the first map area MA1. Because the command corresponds to the first user U1, the storage device 200 may determine whether there is the map data in the first map area MA1 corresponding to the first user U1. The storage device 200 may determine the map data as a cache miss when there is no map data corresponding to the command in the first map area MA1.

In operation S330, the storage device 200 may select a victim entry from the first map area MA1. The storage device 200 may determine whether there is space for loading the map data corresponding to the command in the non-volatile memory device 220. Because the command corresponds to the first user U1, the storage device 200 may determine whether there is a free space in the first map area MA1 corresponding to the first user U1. When there is no free space for loading new map data in the first map area MA1, the storage device 200 may select map data to be removed from the first map area MA1. The storage device 200 may determine a victim entry in the first map area MA1.

In operation S340, the storage device 200 may store the map data corresponding to the victim entry in the non-volatile memory device 220. The storage device 200 may store the map data to be removed from the non-volatile memory device 220. In operation S350, the storage device 200 may unload the victim entry.

In operation S360, the storage device 200 may load the map data corresponding to the command from the non-volatile memory device 220 to the first map area MA1. Because the command corresponds to the first user U1, the storage device 200 may load the map data corresponding to the command to the first map area MA1 corresponding to the first user.

When the storage device 200 does not perform a map cache operation for each user, the second user U2 may access only a preset address area (that is, when there is locality), and it is assumed that the map data corresponding to the preset address area is previously loaded to the memory 230. In this case, when the first user U1 receives a command and selects a victim entry, the map data of the second user U2 may be selected as the victim entry. An issue may occur in that, when the map data of the second user U2 is unloaded, the second user U2 has to load the map data again due to workload of the first user U1. This may lead to increased latency and decreased performance for the second user U2.

As described above, the storage device 200 may individually manage map data for multiple users. That is, the storage device 200 may configure a map cache of the memory 230 as a map table that is separately allocated for each of multiple users. The storage device 200 may determine the map area corresponding to the command as the target map area and load or unload the map data into or from a target map area. Accordingly, the map cache for the second user U2 may not be affected in a process of processing the command for the first user U1.

Also, the storage device 200 may easily detect an input/output pattern for each user. The storage device 200 may optimize map data loading or unloading based on the input/output pattern. For example, when the input/output pattern of the first user U1 is a sequential pattern, the storage device 200 may load the map data of the next address in advance, and when selecting the unload map data from the first map area MA1, the next address map data may be excluded from an unload target. The storage device 200 may increase a map cache hit ratio.

FIG. 7A to FIG. 7D are diagrams illustrating example operations of the storage system 10 of FIG. 1 according to some implementations. In FIG. 1, and 7A to 7D, the host 100 may include the first user U1 and the second user U2. However, the scope of the present disclosure is not limited thereto, and the number of users may be reduced or increased depending on implementations. For example, the host 100 may include a first virtual machine and a second virtual machine. Alternatively, the host 100 may include a first application and a second application.

The storage device 200 may include the storage controller 210, the non-volatile memory device 220, and the memory 230. The non-volatile memory device 220 may include first map data MD11 to MD18 and second map data MD21 to MD28. The first map data MD11 to MD18 may indicate all map data corresponding to the first user U1. The second map data MD21 to MD28 may indicate all map data corresponding to the second user U2.

The memory 230 may include the first map area MA1 and the second map area MA2. The first map area MA1 may correspond to the first user U1, and the second map area MA2 may correspond to the second user U2. Some data MD11, MD13, MD16, and MD17 of the first map data MD11 to MD18 stored in the non-volatile memory device 220 may be stored in the first map area MA1. Some data MD21 of the second map data MD21 to MD28 stored in the non-volatile memory device 220 may be stored in the second map area MA2.

In operation S410, the host 100 may transmit a command including a first user identifier UID1 to the storage device 200. For example, the first user U1 (or the first virtual machine) may transmit the command including the first user identifier UID1 to the storage device 200.

The storage controller 210 may determine the first map area MA1 as a target map area based on the first user identifier UID1 included in the command. The storage controller 210 may determine whether there is map data corresponding to the command in a target map area. For example, the storage controller 210 may determine whether there is map data corresponding to an address included in the command in the first map area MA1. It is assumed that there is no map data corresponding to the command in the first map area MA1. It is assumed that the first map area MA1 has no free space for new map data.

In operation S420, the storage controller 210 may select a victim entry in the first map area MA1. Because there is no map data corresponding to the command in the first map area MA1, the storage controller 210 may determine whether there is a space for storing new map data in the first map area MA1. Because the first map area MA1 has no free space for new map data, the storage controller 210 may select map data to be removed from the first map area MA1. The storage controller 210 may determine the map data to be removed based on a first map cache policy corresponding to the first user U1. For example, the storage controller 210 may select the map data MD11 to be removed from the first map area MA1.

In operation S430, the storage controller 210 may store the map data MD11 of the first map area MA1 in the non-volatile memory device 220. For example, the map data MD11 of the first map area MA1 may be updated map data, and the map data MD11 of the non-volatile memory device 220 may be previous map data. That is, the storage controller 210 may store, in the non-volatile memory device 220, the updated map data in the map cache.

In operation S440, the storage controller 210 may unload the map data MD11 of the first map area MA1. In operation S450, the storage controller 210 may load the map data MD15 corresponding to the command from the non-volatile memory device 220 to the first map area MA1. The storage controller 210 may process a command based on the loaded map data.

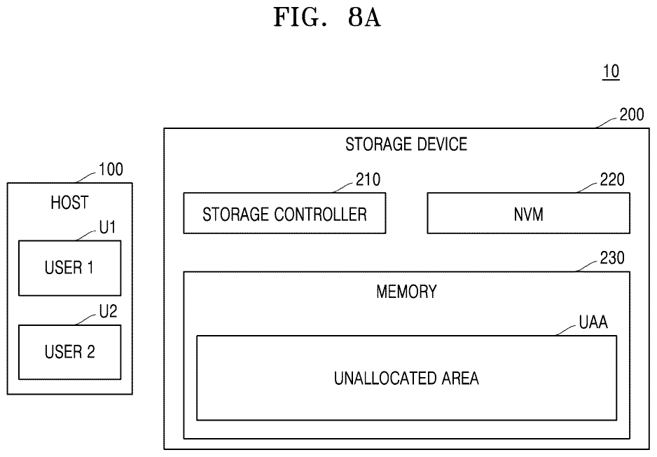

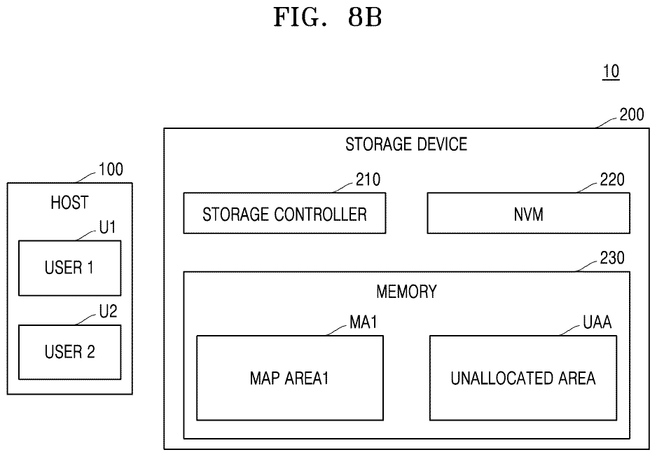

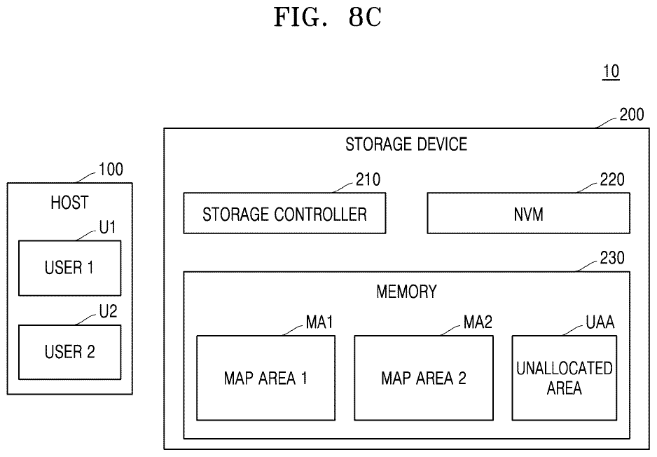

FIG. 8A to FIG. 8C are diagrams illustrating example operations of the storage system 10 of FIG. 1 according to some implementations. For the sake of convenience of description, detailed descriptions of the components described above are omitted. The storage system 10 may individually allocate map areas based on user requirements and patterns. Hereinafter, a method of allocating, by the storage system 10, the map areas is described based on a performance bandwidth among the user requirements. However, the scope of the present disclosure is not limited thereto, and the storage system 10 may allocate the map areas based on the user requirements or input/output patterns. For example, the storage system 10 may allocate the map areas based on capacities of multiple users.

It is assumed that the storage system 10 allocates 50% of the total performance of the storage device 200 to the first user U1 and allocates 25% of the total performance of the storage device 200 to the second user U2.

In some implementations, the storage device 200 may allocate the map areas in proportion to the user requirements. The storage device 200 may allocate the map areas respectively to multiple users in proportion to the performance bandwidth included in the user requirements. In some implementations, the storage device 200 may allocate the map areas respectively to the multiple users in proportion to the capacity allocated to each user from the total capacity of the storage device 200.

In FIG. 8A, after an initial state or an initialization operation is performed, the memory 230 may include a map table area. The map table area may include an unallocated area UAA. The entire map table area may be the unallocated area UAA. Before the map areas are respectively allocated to the multiple users, the memory 230 may include only the unallocated area UAA.

In FIG. 8B, the host 100 may transmit a user requirement including first performance information (for example, 50% of the total performance) to the storage device 200 in relation to the first user U1. The storage device 200 may allocate the first map area MA1 to the first user U1 based on the user requirement. The storage device 200 may allocate the first map area MA1 having a first size (for example, 50% of the entire map table area) based on the first performance information. Accordingly, the size of the unallocated area UAA may be reduced by the size of the first map area MA1 from the size of the entire map table area in the initial state.

In FIG. 8C, the host 100 may transmit a user requirement including second performance information (for example, 25% of the total performance) to the storage device 200 in relation to the second user U2. The storage device 200 may allocate the second map area MA2 to the second user U2 based on the user requirement. The storage device 200 may allocate the second map area MA2 having a second size (for example, 25% of the entire map table area) based on the second performance information. Accordingly, the size of the unallocated area UAA may be reduced by the size of the first map area MA1 and the second map area MA2 from the size of the entire map table area in the initial state. A ratio of the first performance to the second performance may be equal to similar to a ratio of the first size to the second size.

As described above, the storage system 10 may allocate the map areas respectively to multiple users in proportion to performance bandwidths of users. When the first user U1 requests the first performance and the second user U2 requests the second performance, the storage system 10 may allocate the first map area MA1 having a first size to the first user U1 and allocate the second map area MA2 having a second size to the second user U2.

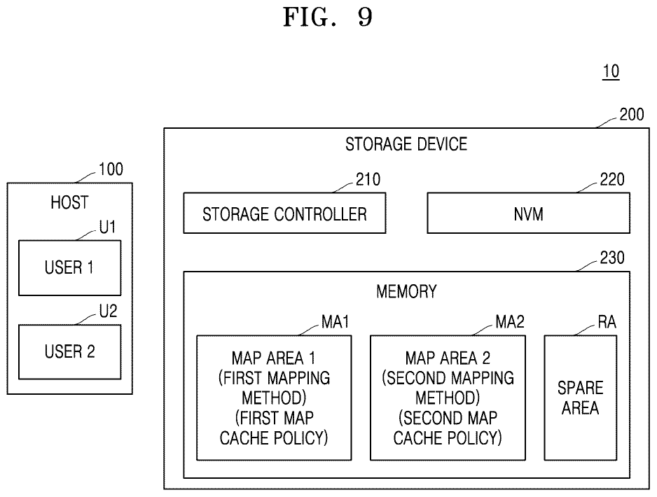

FIG. 9 is a diagram illustrating an example operation of the storage system 10 of FIG. 1 according to some implementations. In FIGS. 1 and 9, the memory 230 may include the first map area MA1, the second map area MA2, and a spare area RA. The storage device 200 may individually allocate map areas to multiple users based on user requirements or input/output patterns. A first map area MA1 may correspond to the first user U1, and a second map area MA2 may correspond to the second user U2. The first map area MA1 may include map data (or a map table) corresponding to the first user U1. The second map area M2 may include map data (or a map table) corresponding to the second user U2.

The storage device 200 may individually set a mapping method to each of multiple users based on user requirements or input/output patterns. The mapping method may refer to either a first mapping method or a second mapping method. For example, the first mapping method may be a page mapping method, and the second mapping method may be a block mapping method. The storage device 200 may set the first mapping method to the first user U1 and the second mapping method to the second user U2. However, the scope of the present disclosure is not limited thereto, and the mapping method may further include hybrid mapping in which page mapping is mixed with block mapping.

The storage device 200 may individually set a map cache policy to each of multiple users based on user requirements or input/output patterns. For example, the storage device 200 may set a first map cache policy to the first user U1 and allocate a second map cache policy to the second user U2. The storage device 200 may manage the first map area MA1 based on the first map cache policy. The storage device 200 may manage the second map area MA2 based on the second map cache policy.

For example, when the input/output pattern of the first user U1 is mainly random, the storage device 200 may set a page mapping method to the first user U1 and allocate the first map area MA1 having a large size. When the input/output pattern of the second user U2 is mainly sequential, the storage device 200 may set a block mapping method to the second user U2 and allocate the second map area MA2 having a small size.

The memory 230 may include a map table area. The size of the map table area may be determined in advance. The size of the map table area may be fixed or selected to be variable by a designer, a manufacturer, and/or a user. The map table area may include the first map area MA1, the second map area MA2, and the spare area RA. The spare area RA may be an area that is not allocated to a certain user. The spare area RA may be a public area. For example, the spare area RA may be a storage space allocated to respond to an exceptional situation for each user. The exceptional situation may indicate a situation in which performance degradation occurs, such as when a garbage collection operation or defensive code is performed.

In some implementations, the storage controller 210 may temporarily lend the spare area RA to a certain user who has an exceptional situation to prevent the performance degradation. The storage controller 210 may lend the spare area RA to a certain user as needed and retrieve the spare area RA again. For example, when the garbage collection operation is performed in a storage area corresponding to the first user U1, the first user U1 may use the spare area RA.

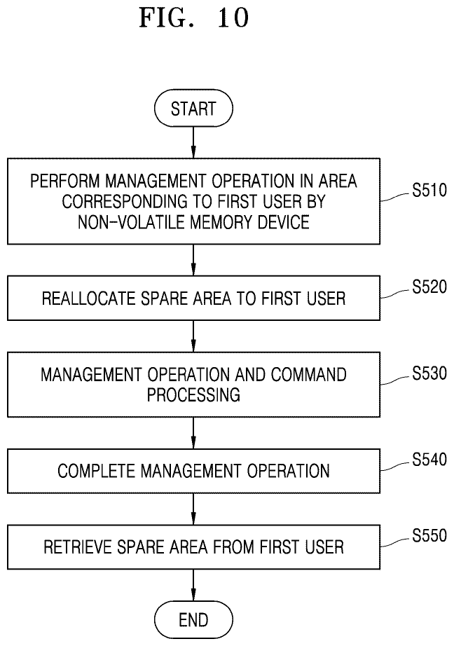

FIG. 10 is a flowchart illustrating an example of an operating method of the storage device 200 of FIG. 1 according to some implementations. In FIGS. 1, 9, and 10, the memory 230 of the storage device 200 may include the spare area RA. The storage device 200 may lend the spare area RA to a certain user as needed and retrieve the spare area RA again.

In operation S510, the non-volatile memory device 220 of the storage device 200 may perform a management operation on a storage area corresponding to the first user U1. For example, the management operation may include a garbage collection operation on an area of the non-volatile memory device 220. The management operation may include a wear leveling operation on an area of the non-volatile memory device 220. The management operation may include an operation of adjusting an operating voltage level that is used during an internal operation of the non-volatile memory device 220. The storage device 200 may require an additional map area due to the management operation.

In operation S520, the storage device 200 may reallocate the spare area RA to the first user U1. The non-volatile memory device 220 of the storage device 200 may reallocate (or lend) the spare area RA for the first user U1 in response to the management operation being performed in a storage area corresponding to the first user U1. In some implementations, when the spare area RA is reallocated to a certain user, other users may use the spare area RA. In some implementations, the storage device 200 may reallocate the entire spare area RA to the first user U1. In some implementations, the storage device 200 may reallocate a part of the spare area RA to the first user U1. In this case, the storage device 200 may reallocate the other parts of the spare area RA to the second user U2.

In operation S530, the storage device 200 may perform the management operation based on the spare area RA and the first map area MA1 and process a command related to the first user U1. Accordingly, the storage device 200 may require an additional map area in the process of performing an additional operation related to the first user U1 due to the management operation. In this case, the storage device 200 may shorten the processing time by utilizing the spare area RA.

In operation S540, the management operation of the storage device 200 may be completed. The management operation related to the first user U1 may be terminated. In operation S550, the storage device 200 may retrieve the spare area RA from the first user U1. For example, the non-volatile memory device 220 of the storage device 200 may retrieve the spare area RA from the first user U1 in response to the completion of the management operation in a storage area corresponding to the first user U1. The retrieved spare area RA may be used again as a public area by other users.

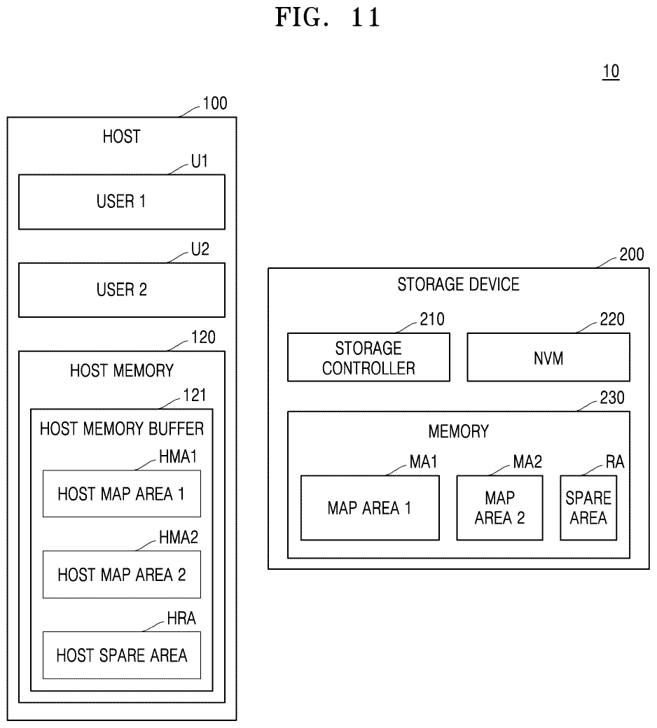

FIG. 11 is a block diagram illustrating an example of the storage system 10 of FIG. 1 according to some implementations. For the sake of convenience of description, detailed descriptions of the components described above are omitted. The host 100 may include the first user U1, the second user U2, and the host memory 120. For example, the first user U1 may be a first virtual machine, and the second user U2 may be a second virtual machine.

The host memory 120 may include a host memory buffer 121. The host 100 may allocate a partial area of the host memory 120 as a buffer of the storage device 200. Hereinafter, the partial area of the host memory 120 allocated as a buffer of the storage device 200 is referred to as a host memory buffer (HMB) 121.

In some implementations, the host memory buffer 121 may be allocated such that the storage device 200 may use the host memory 120 as a buffer. The host memory buffer 121 may be managed by the storage device 200. The host memory buffer 121 may store data of the storage device 200. For example, map data, metadata, a mapping table, or so on of the storage device 200 may be stored in the host memory buffer 121.

The storage device 200 may allocate map areas of the memory 230 respectively to multiple users. The memory 230 may include the first map area MA1, the second map area MA2, and the spare area RA. The storage device 200 may individually allocate map areas to multiple users based on user requirements of the multiple users or input/output patterns of the multiple users. For example, the storage device 200 may allocate the first map area MA1 to the first user U1 and allocate the second map area MA2 to the second user U2 based on a requirement of the first user U1, input/output patterns of the first user U1, a requirement of the second user U2, and input/output patterns of the second user U2.

In some implementations, the storage device 200 may perform a map cache operation for each user in the host memory buffer 121. The storage device 200 may allocate each map area of the host memory buffer 121 to each of multiple users. The host memory buffer 121 may include a first host map area HMA1, a second host map area HMA2, and a host spare area HRA. The storage device 200 may individually allocate host map areas of the host memory buffer 121 to multiple users based on user requirements of the multiple users or input/output patterns of the multiple users. For example, the storage device 200 may allocate the first host map area HMA1 to the first user U1 and allocate the second host map area HMA2 to the second user U2 based on a requirement of the first user U1, input/output patterns of the first user U1, a requirement of the second user U2, and input/output patterns of the second user U2.

In some implementations, the storage device 200 may lend the host spare area HRA to a certain user as needed and retrieve the host spare area HRA again. The non-volatile memory device 220 of the storage device 200 may reallocate the host spare area HRA for the first user U1 in response to a management operation being performed in an area corresponding to the first user U1. The storage device 200 may retrieve the host spare area HRA from the first user U1 in response to a management operation being completed in an area corresponding to the first user U1.

The storage device 200 may determine sizes of a plurality of host map areas, determine a mapping method of the plurality of host map areas, or determine a mapping cache policy of the plurality of host map areas based on requirements and input/output patterns of the multiple users. For example, the storage device 200 may manage the first host map area HMA1 based on a first mapping cache policy, and manage the second host map area HMA2 based on a second mapping cache policy.

In some implementations, the user requirement may further include security level information. For example, the storage device 200 may determine ratios between the first and second host map areas HMA1 and HMA2 and the first and second map areas MA1 and MA2 based on the security level information included in the user requirements. For example, when a user requirement of the first user U1 indicates a high security level, the storage device 200 may decrease a size of the first host map area HMA1 and increase a size of the first map area MA1. For example, when a user requirement of the second user U2 indicates a low security level, the storage device 200 may increase a size of the second host map area HMA2 and decrease a size of the second map area MA2. In some implementations, when the requirement of the first user U1 indicates high performance or low latency, the storage device 200 may decrease the size of the first host map area HMA1 and increase the size of the first map area MA1. That is, the storage device 200 may increase the size of the first map area MA1 more than the first host map area HMA1.

As described above, the storage device 200 may use the host memory buffer 121. The storage device 200 may store map data in the host memory buffer 121. The storage device 200 may allocate map areas of the host memory buffer 121 to store map data respectively corresponding to multiple users based on the requirements and input/output patterns of the multiple users. The storage device 200 may manage host map areas based on map cache policies respectively corresponding to multiple users, based on the requirements and input/output patterns of the multiple users.

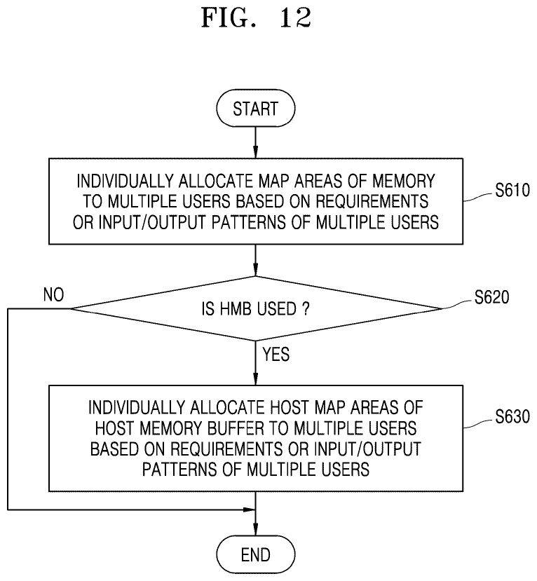

FIG. 12 is a flowchart illustrating an example of the operating method of the storage system 10 of FIG. 1 according to some implementations. In FIGS. 11 and 12, the storage system 10 may perform a map cache operation for each user. In operation S610, the storage system 10 may individually allocate map areas of the memory 230 to multiple users based on requirements or input/output patterns of the multiple users. In operation S620, the storage system 10 may determine whether the host memory buffer 121 is available for use. When the host memory buffer 121 is available for use, the storage system 10 may perform operation S630, and when the host memory buffer 121 is not available, operation S630 may not be performed.

In operation S630, the storage system 10 may individually allocate host map areas of the host memory buffer 121 to multiple users based on requirements or input/output patterns of the multiple users. Based on whether the host memory buffer 121 is available for use, the storage device 200 may allocate the host map areas respectively to the multiple users. For example, the storage device 200 may allocate the first host map area HMA1 based on a requirement and input/output pattern of the first user U1. The storage device 200 may allocate a second host map area HMA2 based on a requirement and input/output pattern of the second user U2.

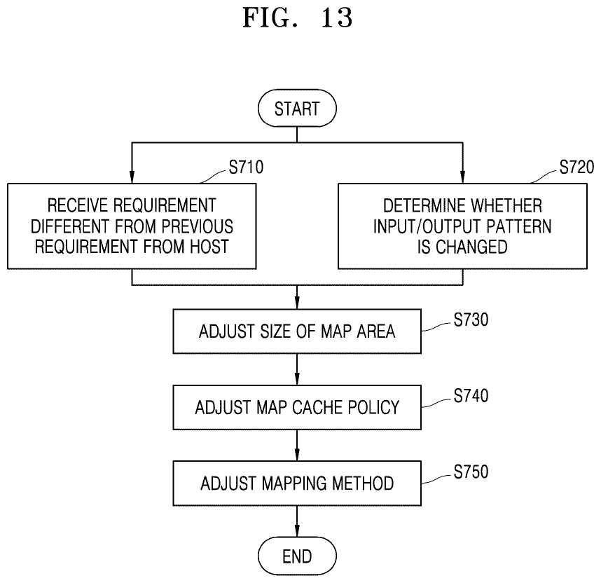

FIG. 13 is a flowchart illustrating an example of an operating method of the storage device of FIG. 1 according to some implementations. In FIGS. 1 and 13, the storage device 200 may perform a map cache operation for each user. During the map cache operation for each user, when a user requirement changes or an input/output pattern changes, the storage device 200 may change at least one of a size of a map area, a map cache policy, and a mapping method.

In operation S710, the storage device 200 may receive a user requirement that is different from a previous user requirement from the host 100. For example, the storage device 200 may receive a new requirement of the first user U1. The new requirement may include any one of changed capacity information, changed performance information, and a changed input/output pattern. The storage device 200 may perform operation S730 after operation S710.

In operation S720, the storage device 200 may perform a monitoring operation to determine whether an input/output pattern of a certain user is changed. The storage device 200 may perform a monitoring operation periodically. The storage device 200 may analyze a result of the monitoring operation to detect that the input/output pattern of the certain user is changed. For example, the storage device 200 may determine that an input/output pattern of the first user U1 is changed. The storage device 200 may determine that the input/output pattern of the first user U1 is changed from a sequential pattern to a random pattern. The storage device 200 may perform operation S730 after operation S720.

In operation S730, the storage device 200 may adjust a size of a map area. The storage device 200 may adjust the size of the map area based on the changed requirement or the changed input/output pattern. For example, the storage device 200 may increase the size of the map area when the input/output pattern of the first user U1 is changed from a sequential pattern to a random pattern. For example, the storage device 200 may increase a size of the first map area MA1 by reducing a size of the spare area RA.

In operation S740, the storage device 200 may adjust a map cache policy. The storage device 200 may adjust the map cache policy based on the changed requirement or the changed input/output pattern. For example, when the input/output pattern of the first user U1 is changed from a sequential pattern to a random pattern, the storage device 200 may change a map cache policy that performs prefetch to a map cache policy that does not perform the prefetch.

In operation S750, the storage device 200 may adjust a mapping method. The storage device 200 may adjust the mapping method based on the changed requirement or the changed input/output pattern. For example, when an input/output pattern of the first user U1 is changed from a sequential pattern to a random pattern, the storage device 200 may change a block mapping method to a page mapping method.

When at least one of operation S710 and operation S720 is performed, the storage device 200 may perform operation S730 to operation S750. When at least one of operation S710 and operation S720 is performed, at least one of operation S730 to operation S750 may be performed.

As described above, the storage device 200 may dynamically adjust at least one of a size of a map area, a map cache method, and a mapping method in response to a requirement or input/output pattern that is changed during an operation. Accordingly, the storage device 200 with improved performance may be provided.

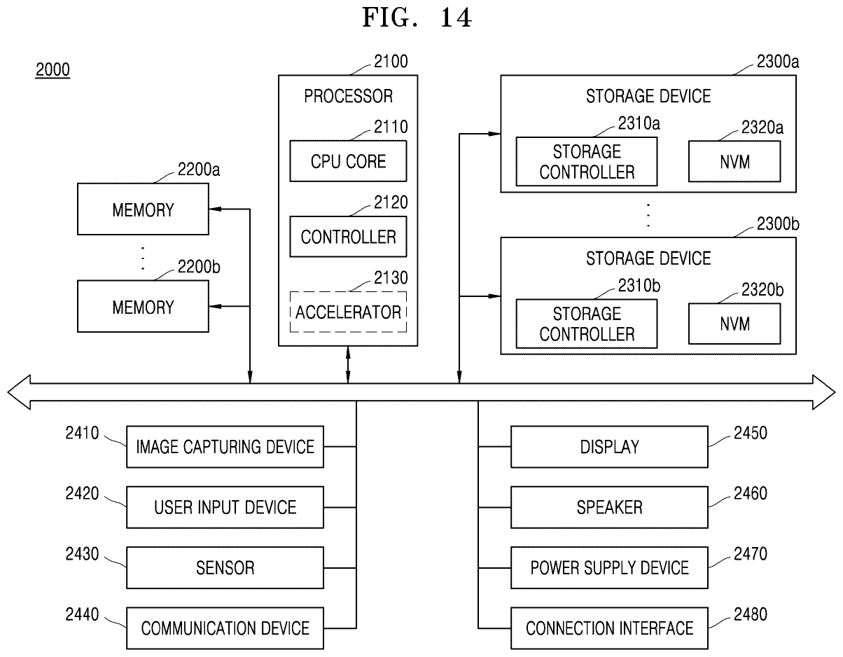

FIG. 14 is a diagram illustrating an example of a system according to some implementations. In FIG. 14, a system 2000 may include a main processor 2100, memories 2200a and 2200b, and storage devices 2300a and 2300b and may further include one or more of an image capturing device 2410, a user input device 2420, a sensor 2430, a communication device 2440, a display 2450, a speaker 2460, a power supply device 2470, and a connection interface 2480.

The main processor 2100 may control all operations of the system 2000, more specifically, operations of other components included in the system 2000. The main processor 2100 may be a general-purpose processor, a dedicated processor, an application processor, or so on.

The main processor 2100 may include at least one central processing unit (CPU) core 2110 and may further include a controller 2120 for controlling the memories 2200a and 2200b and/or the storage devices 2300a and 2300b. Depending on some implementations, the main processor 2100 may further include an accelerator 2130 which is a dedicated circuit for a high-speed data operation, such as an artificial intelligence (AI) data operation. The accelerator 2130 may include a graphics processing unit (GPU), a neural processing unit (NPU), and/or a data processing unit (DPU) and may be implemented as a separate chip that is physically independent from other components of the main processor 2100.

The memories 2200a and 2200b may be used as main memory devices of the system 2000 and may each include volatile memory, such as static random access memory (SRAM) and/or DRAM, but may also include non-volatile memory, such as flash memory, ferroelectric random access memory (FRAM), PRAM, and/or RRAM. The memories 2200a and 2200b may also be provided in the same package as the main processor 2100.

The storage devices 2300a and 2300b may each function as a non-volatile storage device that stores data regardless of whether power is supplied and may each have a relatively larger storage capacity than the memories 2200a and 2200b. The storage devices 2300a and 2300b may respectively include storage controllers 2310a and 2310b and non-volatile memories (NVMs) 2320a and 2320b that store data respectively under the control by the storage controllers 2310a and 2310b. The non-volatile memories 2320a and 2320b may each have a flash memory of a two-dimensional (2D) structure or a three-dimensional (3D) vertical NAND (V-NAND) structure, but may also include other types of non-volatile memory, such as PRAM and/or RRAM.

The storage devices 2300a and 2300b may be included in the system 2000 while being physically separated from the main processor 2100, or may be provided in the same package as the main processor 2100. Also, the storage devices 2300a and 2300b may have the form of a solid state device (SSD) or a memory card, and may be detachably connected to other components of the system 2000 through an interface, such as a connection interface 2480 described below. The storage devices 2300a and 2300b may each be a device to which a standard protocol, such as universal flash storage (UFS), an embedded multi-media card (eMMC), or an NVMe, is applied but is not limited thereto.

The image capturing device 2410 may capture still images or moving images and may be a camera, a camcorder, and/or a webcam.

The user input device 2420 may receive various types of data input from a user of the system 2000 and may be a touch pad, a keypad, a keyboard, a mouse, a microphone, and/or so on.

The sensor 2430 may detect various types of physical quantities that may be obtained from the outside of the system 2000 and convert the detected physical quantities into electrical signals. The sensor 2430 may be a temperature sensor, a pressure sensor, an optical sensor, a position sensor, an acceleration sensor, a biosensor, a gyroscope sensor, and/or so on.

The communication device 2440 may transmit and receive signals to and from other devices outside the system 2000 according to various communication protocols. The communication device 2440 may include an antenna, a transceiver, a modem, and/or so on.

The display 2450 and the speaker 2460 may function as output devices that respectively output visual information and auditory information to a user of the system 2000.

The power supply device 2470 may appropriately convert power supplied from a battery (not illustrated) built in the system 2000 and/or an external power source and supply the power to each component of the system 2000.

The connection interface 2480 may connect the system 2000 to an external device that is connected to the system 2000 and may exchange data with the system 2000. The connection interface 2480 may be implemented in various interfaces, such as an ATA, a SATA, an external SATA (e-SATA), an SCSI, a SAS, a peripheral component interconnection (PCI), a PCIe, an NVMe, IEEE 1394, a USB, a secure digital (SD) card, an MMC, an eMMC, a UFS, an embedded UFS (eUFS), and a compact flash (CF) card interface.

In some implementations, the main processor 2100 may be the host 100 described above with reference to FIGS. 1 to 13. The storage devices 2300a and 2300b may each be the storage device 200 described above with reference to FIGS. 1 to 13. The system 2000 may perform a map cache operation for each user based on the method described above with reference to FIGS. 1 to 13.

The storage devices 2300a and 2300b may collect and manage requirements and input/output patterns of multiple users. The storage device 2300a and 2300b may allocate map areas for each user of the host 100 based on the requirements and input/output patterns of the multiple users. The storage devices 2300a and 2300b may determine mapping methods for each of the multiple users based on the requirements and input/output patterns of the multiple users. The storage devices 2300a and 2300b may determine map cache policies for each of the multiple users based on the requirements and input/output patterns of the multiple users. The storage devices 2300a and 2300b may manage map areas based on the map cache policies respectively corresponding to the multiple users.

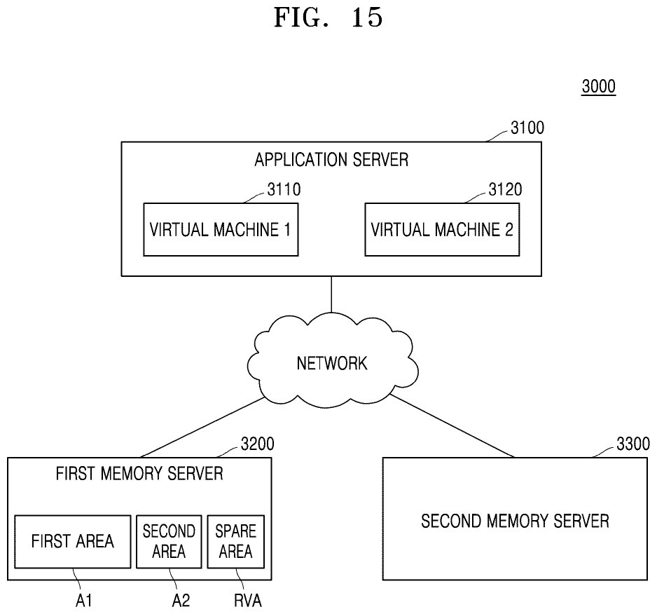

FIG. 15 is a block diagram illustrating an example of a computing system according to some implementations. In FIG. 15, a computing system 3000 may be a facility that maintains various data and provides various services for various data, and may also be a data storage center. The computing system 3000 may be a system for operating a search engine or a database and may be a computing system used in various organizations. The computing system 3000 may include an application server 3100, a first memory server 3200, and a second memory server 3300.

The application server 3100 may include a first virtual machine 3110, and a second virtual machine 3120. The first virtual machine 3110 and the second virtual machine 3120 may each use the first memory server 3200 and the second memory server 3300 in common. The first memory server 3200 may have a smaller storage space and higher performance than the second memory server 3300. For example, the first memory server 3200 may be a cache server of the second memory server 3300.

In some implementations, the first memory server 3200 may store some of the map data stored in the second memory server 3300. The computing system 3000 may perform the map cache operation for each user described above with reference to FIGS. 1 to 13. The computing system 3000 may allocate and manage map cache based on user requirements of a plurality of virtual machines and input/output patterns of the plurality of virtual machines.

For example, the first memory server 3200 may include a first area A1, a second area A2, and a spare area RVA. For example, the computing system 3000 may allocate the first area A1 of the first memory server 3200 to the first virtual machine 3110 based on requirements and input/output patterns of the first virtual machine 3110. The computing system 3000 may allocate the second area A2 of the first memory server 3200 to the second virtual machine 3120 based on requirements and input/output patterns of the second virtual machine 3120. The spare area RVA may be a common area for the first virtual machine 3110 and the second virtual machine 3120. The first area A1 may store map data corresponding to the first virtual machine 3110. The second area A2 may store map data corresponding to the second virtual machine 3120.

In some implementations, the first memory server 3200 may store some of the data stored in the second memory server 3300. The computing system 3000 may perform a data cache operation for each user. The computing system 3000 may allocate and manage a data cache based on user requirements of multiple virtual machines and input/output patterns of the multiple virtual machines.

For example, the first memory server 3200 may include the first area A1, the second area A2, and the spare area RVA. For example, the computing system 3000 may allocate the first area A1 of the first memory server 3200 to the first virtual machine 3110 based on requirements and input/output patterns of the first virtual machine 3110. The computing system 3000 may allocate the second area A2 of the first memory server 3200 to the second virtual machine 3120 based on requirements and input/output patterns of the second virtual machine 3120. The spare area RVA may be a common area for the first virtual machine 3110 and the second virtual machine 3120. The first area A1 may store data corresponding to the first virtual machine 3110. The second area A2 may store data corresponding to the second virtual machine 3120.

According to the present disclosure, a storage device may perform a map cache operation for each user. Accordingly, a storage device, a storage system, and an operating method of the storage device may reduce an interference between users and may improve performance.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A storage device comprising:
a memory;
a non-volatile memory device; and
a storage controller configured to control the non-volatile memory device, communicate with an external host, and perform a map cache operation for each user, of a plurality of users, based on user requirements and data access patterns of the plurality of users, respectively,
wherein the storage controller comprises a map cache manager configured to allocate a first map area of the memory for first map data corresponding to a first user, allocate a second map area of the memory for second map data corresponding to a second user, manage the first map data based on a first map cache policy corresponding to the first user, and manage the second map data based on a second map cache policy corresponding to the second user.

2. The storage device of claim 1, wherein the storage controller comprises a user profile manager configured to receive the user requirements of the plurality of users from the external host and manage the user requirements of the plurality of users.

3. The storage device of claim 2, wherein the user profile manager is configured to monitor the data access patterns of the plurality of users.

4. The storage device of claim 1, wherein the map cache manager is configured to determine a map cache policy based on the user requirements of the plurality of users and the data access patterns of the plurality of users.

5. The storage device of claim 1, wherein the storage controller is configured to
receive a command corresponding to the first user,
determine a victim entry in the first map area based on the first map data corresponding to the command and the first map data being a cache miss in the first map area,
store a second map data corresponding to the victim entry in the non-volatile memory device, and
load the first map data corresponding to the command from the non-volatile memory device to the first map area of the memory.

6. The storage device of claim 1, wherein a size of the first map area is different from a size of the second map area.

7. The storage device of claim 1,
wherein the memory includes the first map area, the second map area, and a spare area, and
wherein the storage controller is configured to reallocate the spare area for the first user based on a management operation being performed in an area corresponding to the first user in the non-volatile memory device, and retrieve the spare area from the first user based on the management operation being completed in the area corresponding to the first user in the non-volatile memory device.

8. The storage device of claim 7, wherein the management operation includes a garbage collection operation for the non-volatile memory device, a wear leveling operation for the non-volatile memory device, or an operation of adjusting an operating voltage level used during an internal operation of the non-volatile memory device.

9. The storage device of claim 1,
wherein the storage controller is configured to determine a mapping method based on the user requirements of the plurality of users and the data access patterns of the plurality of users, and
wherein the mapping method comprises a page mapping method or a block mapping method.

10. The storage device of claim 1, wherein the storage controller is configured to identify the plurality of users using a command queue identifier, a namespace identifier, or a user identifier included in a command.

11. The storage device of claim 1, wherein the storage controller is configured to adjust at least one selected from a size of the first map area, a map cache policy corresponding to the first user, and a mapping method corresponding to the first user.

12. The storage device of claim 11, wherein the storage controller is configured to adjust the size of the first map area based on a new user requirement received from the external host.

13. The storage device of claim 11, wherein the storage controller is configured to adjust the size of the first map area based on a change in a first data access pattern of the first user.

14. A storage system comprising:
a host including a host processor and a host memory; and
a storage device including a storage controller, a memory, and a non-volatile memory device,
wherein the storage controller is configured to allocate map areas of the memory for storing map data respectively corresponding to a plurality of users based on user requirements of the plurality of users and data access patterns of the plurality of users, and
wherein the storage controller is configured to manage the map data respectively corresponding to the plurality of users based on map cache policies respectively corresponding to the plurality of users, and on the user requirements of the plurality of users and the data access patterns of the plurality of users.

15. The storage system of claim 14,
wherein the host memory includes a host memory buffer configured to store the map data of the storage device, and
wherein the storage controller is configured to allocate host map areas of the host memory buffer based on the user requirements of the plurality of users and the data access patterns of the plurality of users.

16. The storage system of claim 15,
wherein the host memory buffer includes the host map areas and a host spare area, and
wherein the storage controller is configured to reallocate the host spare area for a first user among the plurality of users based on a management operation being performed in an area corresponding to the first user in the non-volatile memory device, and retrieve the host spare area from the first user based on the management operation being completed in the area corresponding to the first user in the non-volatile memory device.

17. The storage system of claim 14, wherein the storage controller is configured to receive a command corresponding to a first user among the plurality of users, determine a victim entry in a first map area based on map data corresponding to the command and the map data being a cache miss in the first map area corresponding to the first user, store a second map data corresponding to the victim entry in the non-volatile memory device, and load the map data corresponding to the command from the non-volatile memory device to the first map area of the memory.

18. The storage system of claim 14, wherein the storage controller is configured to adjust at least one selected from a size of a first map area corresponding to a first user among the plurality of users, a map cache policy corresponding to the first user, and a mapping method corresponding to the first user, based on a request from the first user or a change in the data access patterns of the first user.

19. An operating method of a storage device, the operating method comprising:
receiving, by a user profile manager, user requirements for a plurality of users from an external host;
performing, by the user profile manager, a monitoring operation for the plurality of users and determining data access patterns for the plurality of users;
individually allocating, by a map cache manager, map areas of a memory for the plurality of users based on user requirements of the plurality of users and the data access patterns of the plurality of users; and
individually determining, by the map cache manager, map cache policies corresponding to the plurality of users based on the user requirements and the data access pattern of the plurality of users.

20. The operating method of claim 19, comprising individually determining mapping methods corresponding to the plurality of users based on the user requirements and the data access patterns of the plurality of users.
